(19) United States
(12) Patent Application Publication
(10) Pub. No.: US 2007/0011450 A1
(43) Pub. Date: Jan. 11, 2007

(54) System and method for concurrent discovery and survey of networked devices

(76) Inventors: Shawn McCreight, Pasadena, CA (US); Dominik Weber, El Sereno, CA (US)

Correspondence Address: CHRISTIE, PARKER & HALE, LLP, PO BOX 7068, PASADENA, CA, 91109-7068, US

(21) Appl. No.: 10/940,092

(22) Filed: Sep. 14, 2004

(51) Int. Cl. H04L 9/00

(52) U.S. Cl. 713/165

(57) ABSTRACT

A system and method for concurrent investigations of network devices in a data communications network. The network includes an examining machine, a secure server, and various target machines. The secure server receives a request from the examining machine to capture volatile data stored in the target machines, and in response, spawns various processing threads that concurrently attempt connections with the target machines. Upon successful connection with the target machines, a plurality of processes for gathering volatile data are concurrently executed on the responding target machines. The secure server receives the volatile data retrieved and transmitted by the responding target machines. The data is aggregated by the secure server, which transmits the data to the examining machine. The examining machine correlates the received data based on a correlating criteria, and displays the correlated data on a display.

### CROSS-REFERENCE TO RELATED APPLICATION(S)

This application is related in subject matter to U.S. application Ser. No. 10/176,349 filed on Jun. 20, 2002, the content of which is incorporated herein by reference.

### FIELD OF THE INVENTION

This invention relates generally to computer investigation systems, and more specifically, to a system and method for concurrently discovering and surveying networked devices in a computer network.

### BACKGROUND OF THE INVENTION

Application Ser. No. 10/176,349 discloses a system and method for performing secure forensic investigations of networked devices that are active within the organization in an organization over a computer network. Before conducting such an investigation, however, the networked devices that are active within the organization must generally be determined first. Once such devices are identified, analysis and/or survey of those devices may be conducted.

Current mechanisms for identifying active networked devices include serially surveying known network addresses allotted to the organization, one at a time, and determining if a connection may be established at the network address with a networked device. Such serial surveys of network addresses, however, are inefficient and costly, especially when the number of network devices that are active within the organization is considerably less than the total number of network addresses allotted to the organization. This is because if an active device exists at a polled address, the connection is successful and forensic investigation may be conducted on the device in a relatively quick manner. If, however, a particular address does not have a device assigned to it, a significant amount of time is wasted in trying to establish a connection at the particular address. In a typical scenario, about 22 seconds elapse in trying to establish a connection before it is concluded that no connection is possible. In a situation where the organization is allotted 255 network addresses, but only 100 of those addresses are assigned to an active device, leaving a remainder of 155 addresses that are inactive, it would take about one hour just to discern the inactive network addresses from the active network addresses.

Accordingly, what is desired is a system and method in a computer investigations system for concurrently surveying a range of network addresses for actively connected devices, and concurrently investigating those devices during a forensic investigation or network audit.

### SUMMARY OF THE INVENTION

The present invention is directed to a system and method for concurrently investigating a plurality of target devices in a data communications network. A server receives, over a network connection, a request transmitted by a remote device, where the request is associated with a range of network addresses in the data communications network. The server concurrently surveys, in response to the request, at least a portion of the network addresses for a responding target device connected to the network via a surveyed network address. The server establishes concurrent connections with a plurality of the responding target devices, and invokes a plurality of investigative processes where the processes are concurrently executed on the responding target devices. The server transmits to the remote device, connection information associated with the plurality of responding target devices. The remote device then establishes concurrent connections with the plurality of responding target devices based on the connection information. The remote device also concurrently receives data generated by the plurality of responding target devices in response to the investigative processes. The remote device correlates the received data based on a correlating criteria, and displays the correlated data on a display coupled to the remote device.

According to one embodiment of the invention, the server spawns multiple processing threads for establishing the concurrent connections with the target devices.

According to another embodiment of the invention, an investigative process run at a target device retrieves volatile data from a local memory of the target device. The volatile data may be data stored in a random access memory of the target device such as, for example, information on active processes, open communication ports, and open files.

According to another embodiment of the invention, the correlating of data returned by a responding target device includes correlating information on communication ports open on the responding target device with information on processes active on the device, correlating information on processes active on the responding target device with information on files open on the device, and/or correlating information on processes active on the responding target device with information on processes authorized for the target device.

According to another embodiment of the invention, the connection between the server and the remote device, as well as the connection between the server and the target devices, are made secure via an exchange of authentication and/or encryption keys.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of an exemplary computer investigation system allowing concurrent discovery and investigation/survey of networked devices in an organization's computer network;

FIG. 2 is a conceptual layout diagram of a concurrent discovery and investigation of networked devices according to one embodiment of the invention;

FIG. 3 is a flow diagram of a process for obtaining a snapshot of volatile data resident in a target machine according to one embodiment of the invention;

FIG. 4 is a layout block diagram of an exemplary application descriptor and a plurality of machine profiles stored in their respective databases according to one embodiment of the invention;

FIGS. 5A-5F are exemplary screen shots of a graphical user interface for viewing and manipulating snapshot information returned by a target machine according to one embodiment of the invention;

FIG. 6 is a flow diagram of a process for establishing a secure communication between a client software resident in an examining machine and a secure server according to one embodiment of the invention; and

FIG. 7 is a flow diagram of a process for establishing a secure communication between a secure server and a servlet resident in a target machine according to one embodiment of the invention.

### DETAILED DESCRIPTION OF THE INVENTION

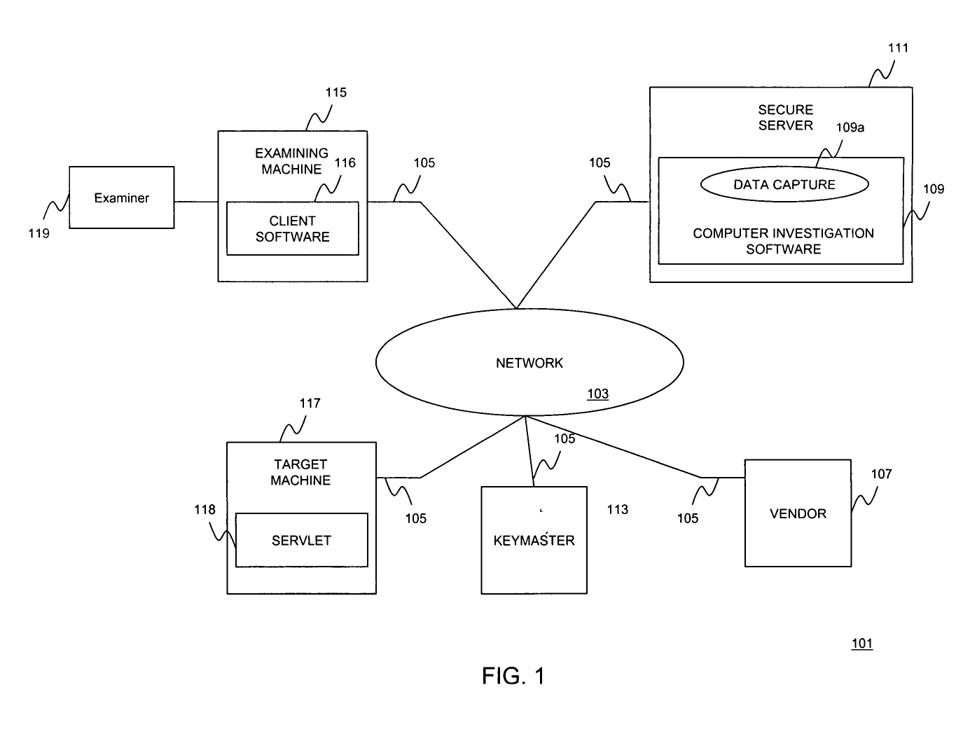

FIG. 1 is a block diagram of an exemplary computer investigation system 101 allowing concurrent discovery and investigation/survey of networked devices in an organization's computer network. The computer investigation system 101 includes various network devices coupled to a data communications network 103 over data communication links 105. The data communications network 103 may be a computer network, such as, for example, a public Internet, a private wide area network (WAN), a local area network (LAN), or other network environment conventional in the art. The network devices may include a vendor computer 107, a secure server 111, an examining machine 115, one or more target machines 117, and a keymaster computer 113. The data communication link 105 may be any network link conventional in the art, such as, for example, an Ethernet coupling.

A vendor having access to the vendor computer 107 provides the organization with a computer investigation software 109 which enables the organization to effectively perform forensic investigations, respond to network safety alerts, and conduct network audits over the data communications network 103. The computer investigation software 109 may also allow other investigations of networked devices in addition to forensic investigations as evident to those of skill in the art.

The investigation software is installed in a local memory of the secure server 111 allocated to the organization. According to one embodiment of the invention, the computer investigation software 109 provides computer program instructions which, when executed by one or more processors resident in the secure server 111, cause the secure server to broker safe communication between the examining machine 115 and the target machines 117. The computer investigation software further facilitates the administration of users, logs transactions conducted via the server, and controls access rights to the system.

According to one embodiment of the invention, the computer investigation software 109 includes a data capture module 109a which allows the concurrent discovery and investigation of the target machines 117. Once discovered, the target machines may be concurrently investigated for forensic or other types of analysis and/or investigation.

The data capture module 109a may be implemented as a software module that is executed by one or more processors resident in the secure server 111, and may include one or more sub-modules dedicated to different aspects of the discovery and/or investigation process. The data capture module 109a may be included as part of the computer investigation software 109, or reside as a module separate from the computer investigation software.

The examining machine 115 allows an authorized examiner 119 to conduct a concurrent investigation/survey of the target machines 117. The examining machine 115 includes a client software 116 which includes the functionality and interoperability for remotely accessing the secure server 111 and corresponding target machines 117.

Each target machine 117 is exemplarily the subject of a computer investigation conducted by the examining machine 115. According to one embodiment of the invention, the target machines run on different operating platforms, such as, for example, operating platforms known as Windows®, Linux®, AIX®, or Solaris®. A servlet 118 installed on a particular target machine 117 allows the examining machine 115 to remotely discover, preview, and acquire data from the target machine, and transmit the acquired data to the examining machine 115 in a secure, platform-independent manner.

The computer investigation system 101 illustrated in FIG. 1 further includes an examiner 119 who has access to a client computer 113. According to one embodiment of the invention, the examiner is a trusted individual who safely stores in the client computer, one or more encryption keys used for authenticating to the secure server and conducting the secure investigation of the target machines.

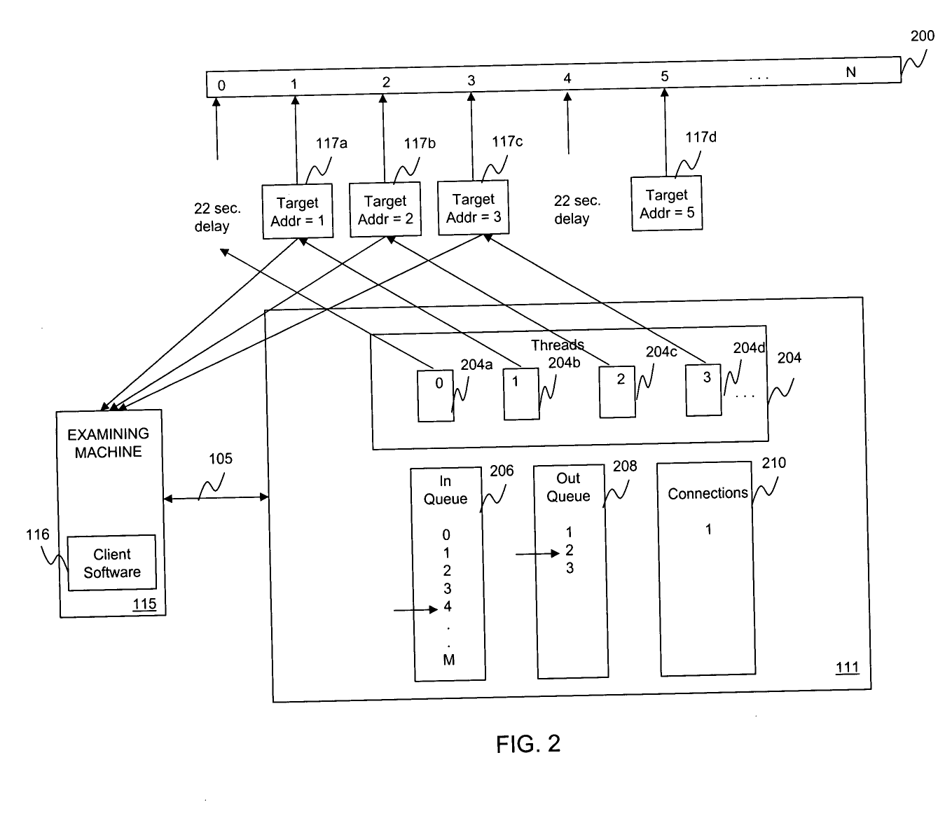

FIG. 2 is a conceptual layout diagram of a concurrent discovery and investigation of networked devices conducted by the data capture module 109a according to one embodiment of the invention. The concurrent discovery and investigation may be triggered in response to receipt of an alert of an intrusion on the network, or based on a routine network audit schedule.

In the illustrated embodiment, a total of N network addresses 200, such as, for example, N internet protocol (IP) addresses, are allocated to an organization. Of these N network addresses 200, addresses “0” and “4” are not assigned to any target machine. Network address “1” is assigned to target machine 117a, network address “2” is assigned to target machine 117b, network address “3” is assigned to target machine 117c, network address “5” is assigned to target machine 117d, and network address “6” is assigned to target machine 117b.

The client software 116 in the examining machine 115 initiates the concurrent discovery and investigation process by transmitting to the secure server 111, a data capture request using the data communication link 105. The data capture request may include various parameters, including parameters that indicate the range of network addresses or names of machines to be surveyed, the number of concurrent connections to be formed with the target machines 117, and the data to be captured on the target machines 117. The number of requested concurrent connections may depend on the number of connections purchased by the organization. In the illustrated embodiment, the requested number of concurrent connections is four.

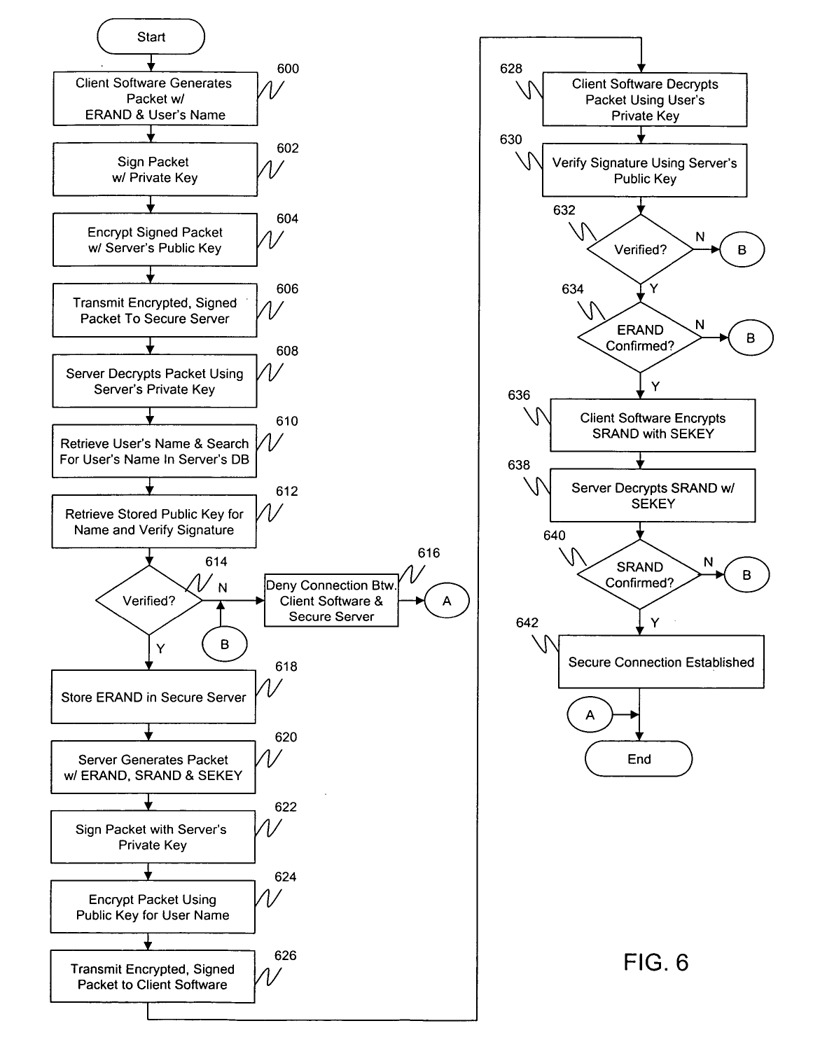

According to one embodiment of the invention, the data capture request, as well as other data generated during the session, is transmitted over a server connection established between the examining machine 115 and the secure server 111, as is described in further detail below with respect to FIG. 6.

The secure server 111 receives the data capture request and in response, invokes the data capture module 109a for concurrently auditing at least a portion of the network addresses and establishing concurrent connections with the target devices connected to the network at the audited addresses. In this regard, the server 111 has access to an in-queue 206 which stores the range of network addresses to be surveyed. According to one embodiment of the invention, a single processor resident in the secure server 111 spawns multiple processing threads 204 where each processing thread attempts to establish a connection with a particular target device. The number of processing threads that are spawned depends on the number of concurrent connections authorized for the organization. The data capture module 109a assigns to each processing thread, a network address from the in-queue 206. In the illustrated embodiment, thread 204a is assigned network address “0,” thread 204b is assigned network address “1,” thread 204c is assigned network address “2,” and thread 204d is assigned network address “3.” The in-queue 206 in this embodiment is a thread-safe queue implemented via semaphores common to multitasking systems.

According to another embodiment of the invention, the secure server 111 includes multiple processors that are concurrently invoked and allocated a network address from the in-queue 206 for attempting to establish a connection with a target machine.

In the illustrated embodiment, the spawned threads 204 concurrently attempt to establish connections with the target machines at their respectively assigned network addresses. Thread 204a cannot establish a network connection because there is no target machine connected to network address “0.” Thread 204a, thus, remains in a waiting state until a determination is made that no connection may be established. Such a determination is made according to conventional mechanisms, which generally takes about 22 seconds to complete. While thread 204a is in the waiting state, however, it does not consume processing power and does not inhibit the other threads from concurrently performing their tasks.

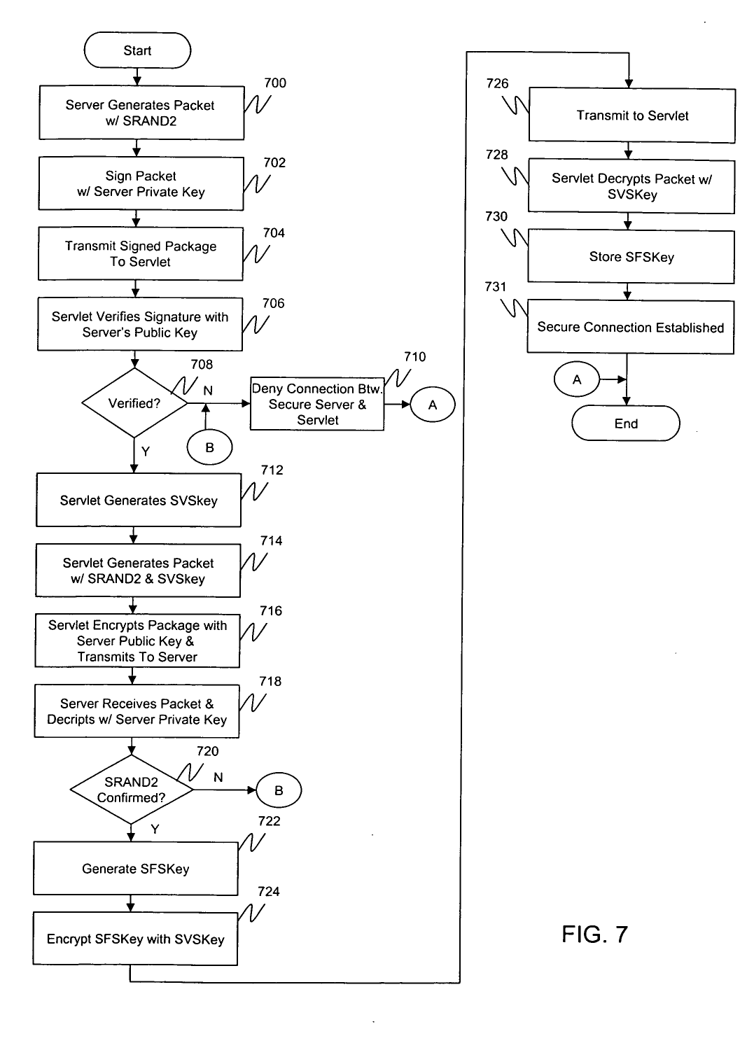

Threads 204b, 204c, and 204d concurrently establish secure connections with respectively target machines 117a, 117b, and 117c. The process for establishing a secure connection between the server 111 and a target machine is described in further detail below with respect to FIG. 7.

As soon as a secure connection is established, the connecting thread transmits a command to the target machine's servlet 118 instructing it to execute an indicated process. Several processes may be executed concurrently at various target machines at a given time. Thus, as the number of concurrent connections C increase, the time T for running a process on multiple machines on the network approaches a time t for running the process on a single machine. Specifically, T approaches N/C*t, where N is a total number of machines executing the process, C is a total number of concurrent connections, and t is the time for running the process on a single machine.

According to one embodiment of the invention, the process that is run on each target machine is obtaining a snapshot of volatile data resident in the target machine and returning the snapshot data in a platform-independent manner. A person of skill in the art should recognize, however, that other processes may also be run by the servlet 118. For example, the process may include searching for a particular keyword on each target machine, computing the hash value of files on each target machine, reading the system registry on each target machine, identifying different file types on each target machine, or acquiring a duplicate forensic image of media, or portions thereof, on the target system 117.

Once a secure connection is established between the secure server 111 and a target machine, the connecting thread outputs the connecting machine's network address into an out-queue 208. The thread is then assigned a new network address from the in-queue 206, and a connection is attempted with a target machine at the new network address.

According to one embodiment of the invention, the client software 116 in the examining machine 115 periodically transmits a request for connections that have been successfully established by the secure server 111. In response to a receipt of such a request 210, the data capture module 109a retrieves the successfully returned network addresses from the out-queue 208, and transmits to the examining machine 115 the retrieved network addresses along with any other information, such as, for example, encryption keys, needed by the client software 116 for communicating with the associated target machines. The retrieved network addresses are also stored in a connections queue 210 which maintains a list of connections that have been handed off to the client software 116. A network address is removed from the connections queue 210 upon notification by the client software 116 that a particular session with the corresponding target machine 115 has been completed.

According to another embodiment of the invention, the results of the processes are transmitted to the secure server 111, which in turn forwards them to the examining machine 115. The results of the processes may be first compressed by the servlet prior to their transmission.

According to one embodiment of the invention, the results returned by each servlet are independent of the target machine's operating platform. This allows the receiving client software 116 to process and correlate the returned data into a database that may then be searched, sorted, viewed, and manipulated by an examiner in a uniform manner.

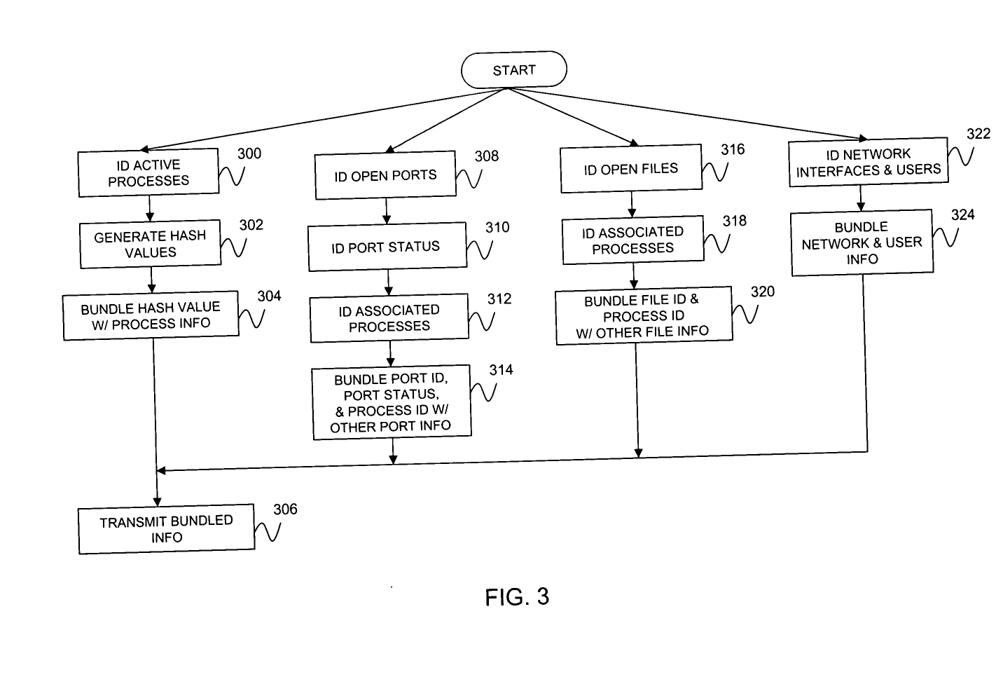

FIG. 3 is a flow diagram of a process run by a servlet for obtaining a snapshot of volatile data resident in the target machine responsive to a data capture command transmitted by a connecting thread. According to one embodiment of the invention, volatile data is any data that exists in the target machine that can be gathered quickly or would be lost when the machine loses power or experiences a system fault. Such data may include data stored in the machine's random access memory, including data on open communication ports, open files, running processes and applications, system resource utilization, and user login information. The capture of volatile data allows the data to be maintained, and helps the examiner determine any suspicious activities occurring on the machine at the time of the investigation.

According to one embodiment of the invention, the process of obtaining snapshot data includes the identification of active processes, open communication ports, open files, and network interfaces and users, for a specific target machine. A person of skill in the art should recognize, however, that other types of volatile data may also be captured without being limited to the above.

Accordingly, in step 300, each servlet with which a connection is established proceeds to identify the active processes that are currently running on the target machine. This may be accomplished, for example, by examining its local memory for stored process identifiers (IDs) assigned by the machine's operating system. The executable files for the identified processes are retrieved based on the process identifiers, and analyzed for generating a unique digital fingerprint of the process in step 302. The fingerprint may take the form of a hash value that is generated upon processing the application's digital data file with a hashing algorithm, such as, for example, an MD5 hashing algorithm. Other information about the process may also be retrieved from the local memory, such as, for example, a date and time the process started, information on who and/or what spawned the process, the types of parameters passed to the process, and the like. Each hash value and associated process information is bundled together in step 304, and transmitted in step 306 to the examining machine 115 via the secure server 111.

In step 308, the responding servlet further identifies the ports that are open on the target machine. This may be accomplished, for example, by examining the target machine's local memory and retrieving the port IDs stored in the memory for the open communication ports. For each identified open port, the servlet also retrieves from the local memory in step 310, a current status for the port. A port may be in a listening state where the port is waiting for a connection to be established. A port may be in an established state where a connection has already been established with the port. A port may further be in a waiting state where a process tied to the port is waiting for additional information.

In step 312, the servlet identifies the process identifiers of the processes associated with the open ports. The identified processes may be, for example, the same processes identified in steps 300-304 as being active on the target machine. In step 314, the servlet bundles the port information retrieved from the local memory for each port, including the port ID, port status, process ID, and other port information, and transmits the bundled information to the secure server 111 in step 306, where it is aggregated and transmitted to the examining machine 115.

In step 316, the connected servlet identifies the files that are currently open on the target machine. This may be accomplished, for example, by searching the local memory for file identifiers stored in the memory for the open files. Information on open files may give an examiner an understanding of what information a perpetrator or application is accessing, and allow the examiner to take appropriate corrective measures in response.

In step 318, the responding servlet further identifies for the open files, the process identifiers of the processes accessing the open files. The identified processes may be, for example, the same processes identified in steps 300-304 as being active on the target machine. In step 320, the file ID, and other types of information about each open file are bundled together, and transmitted in step 306.

In step 322, the servlet retrieves from the local memory information on network interfaces and users of the target machine. In this regard, the servlet retrieves for each identified network interface card, information on the manufacturer of the network interface card, an assigned IP address, a media access controller (MAC) address, a subnet mask, and the like through a query to the operating system of target machine 117. Network user information retrieved from the live Windows® Registry in memory may include, for each user, a user name, a security ID, and a last date/time of login.

In step 324, the network and user information is bundled together and transmitted to the secure server 111, where it is aggregated and transmitted to the examining machine 115.

The examining machine 115 receives the data transmitted from the secure server 111, aggregated for each target machine 117, and sorts and correlates the data into a local database for viewing and manipulating via a graphical user interface (GUI) generated by the client software 116. According to one embodiment of the invention, the client software 116 accesses application descriptors and machine profiles respectively stored in an application descriptor database and a machine profile database, for flagging processes that are deemed to be suspicious. The application descriptors and machine profiles are generated by an administrator via the GUI.

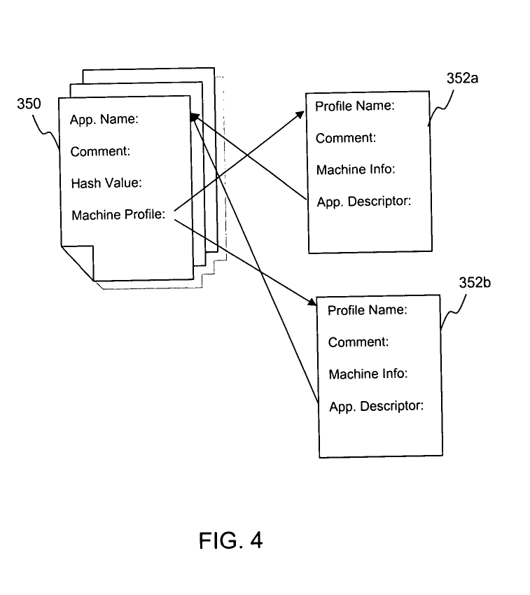

FIG. 4 is a layout block diagram of an exemplary application descriptor 350 and a plurality of machine profiles 352a, 352b stored in their respective databases according to one embodiment of the invention. The application descriptor and machine profile databases may be maintained by either the examining machine 115 or other trusted servers on the network.

The application descriptor includes for a particular application or process (collectively referred to as a process), a corresponding hash value that uniquely identifies the process. The application descriptor further maintains an application name and comments that provide additional descriptions of the process. The application descriptor is associated with one or more machine profiles 352a, 352b that are authorized to run the process.

A machine profile 352a, 352b provides a machine profile name (e.g. “Windows 2000”), a comment further describing the profile (e.g. “workstation”), one or more machine identifiers of machines to which the machine profile applies, and a link to one or more application descriptors generated for processes that have been authorized for the profile. According to one embodiment of the invention, it is an administrator who indicates the application descriptors that are authorized for a particular machine profile.

Given the application descriptors and associated machine profiles, the client software may, upon receipt of snapshot data returned by a particular target machine, give descriptive information about the processes including their authorization information. In this regard, the examiner uses the GUI provided by the client software 116 to transmit a command to view the snapshot data gathered for one or more target machines. In response to the command, the client software searches the application descriptors database for the application descriptors of the returned processes based on their respective hash values. The use of hash values as process identifiers allows processes to be identified even if the processes are run under different names.

If a match is made, all or a portion of the application descriptor information is displayed on the examining machine's display monitor. If no match is made, the application descriptor column 464 is blank for the process, alerting the examiner that an unknown process is running on the target machine 117.

The client software 116 further searches the machine profiles database for the machine profiles of the target machines returning the snapshot data. For a particular target machine, the client software determines if the application descriptor of an application active on the machine is included in the machine's profile. If the application descriptor is included, the process is authorized to run on the machine, and an “approved” message is displayed. If the application descriptor is not included in the machine's profile, the process is not authorized, and a “not approved” message is displayed. If a machine profile does not exist for a particular process, a “no profile” message is displayed.

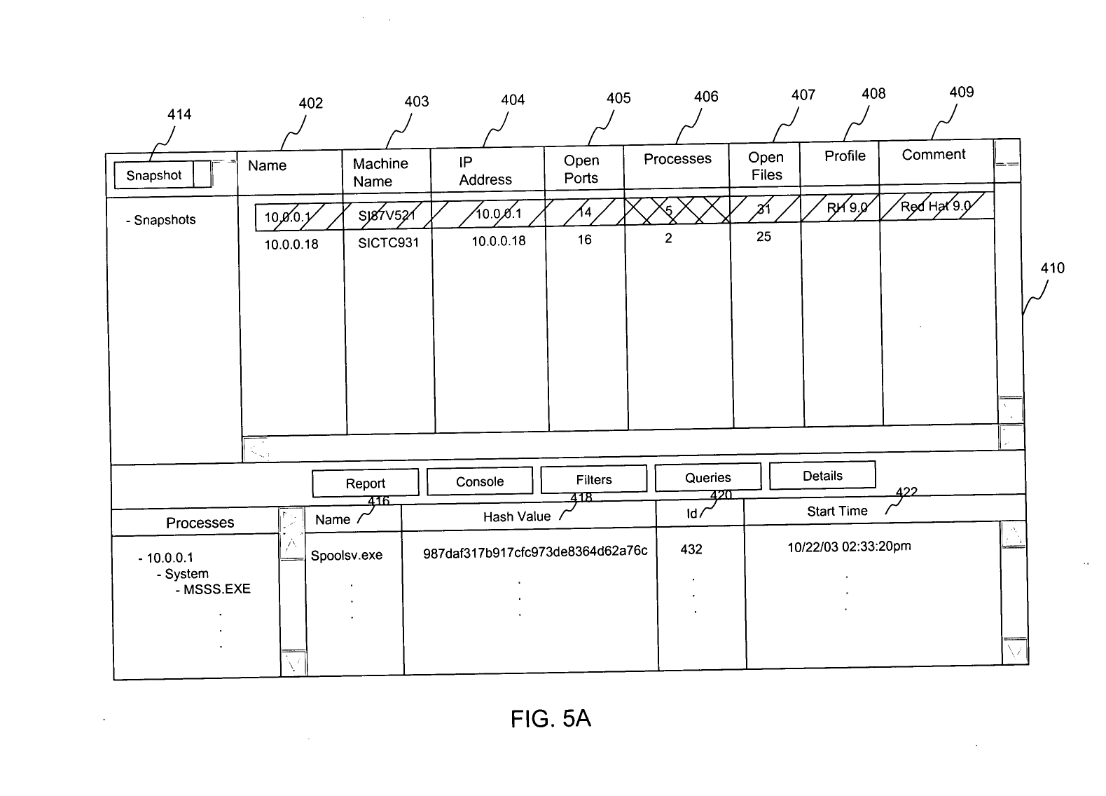

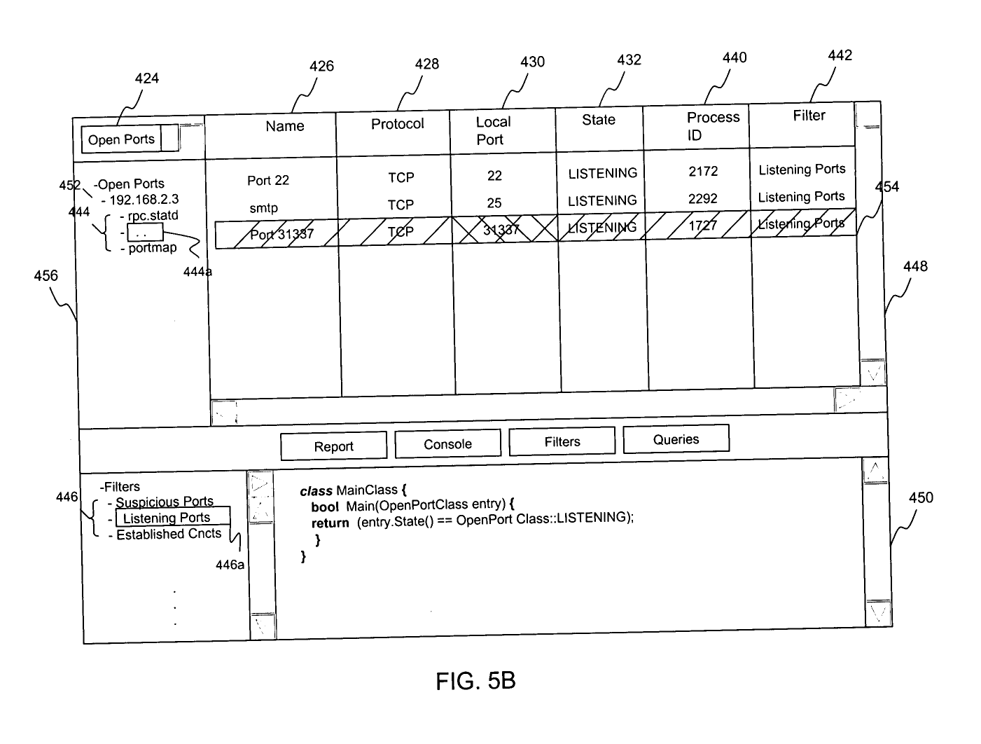

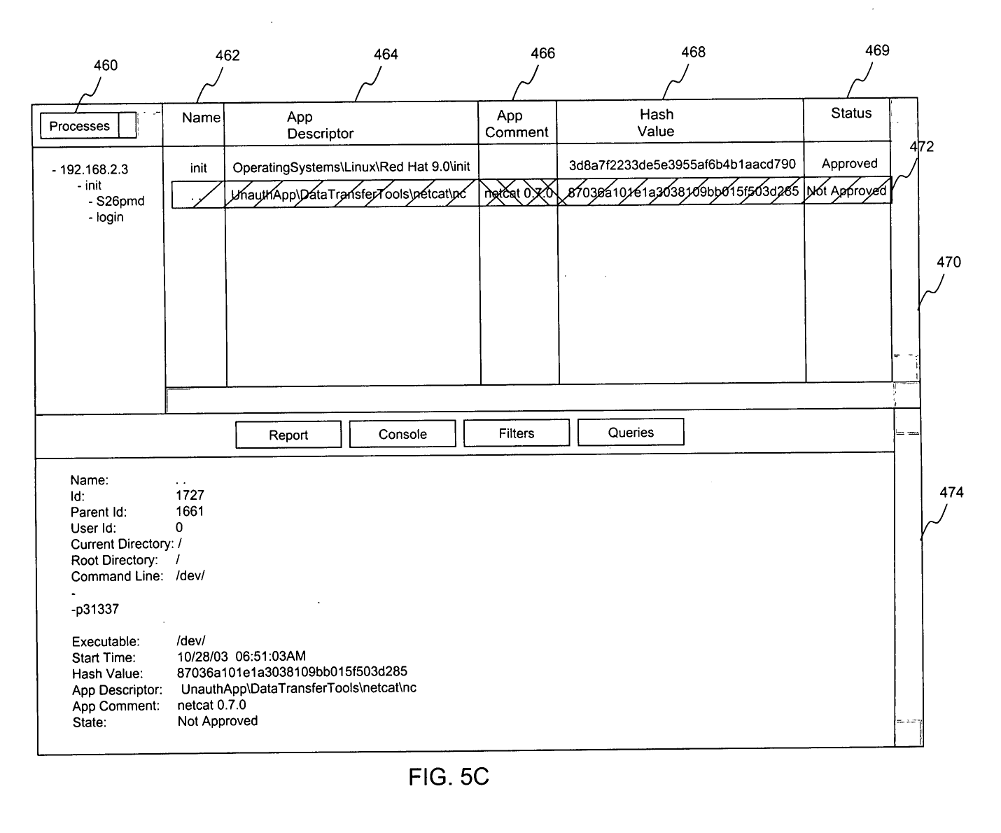

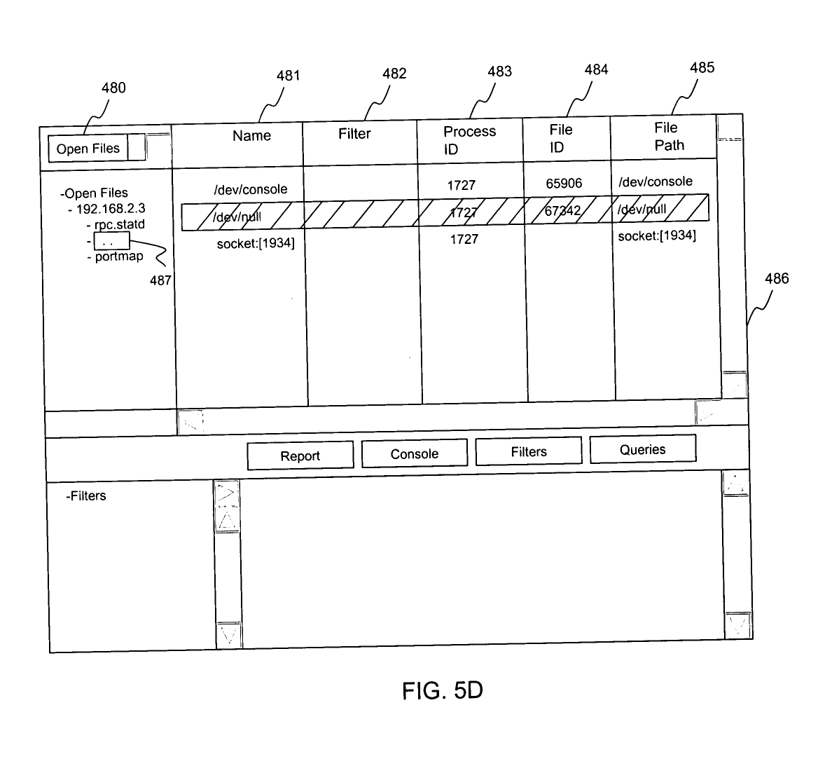

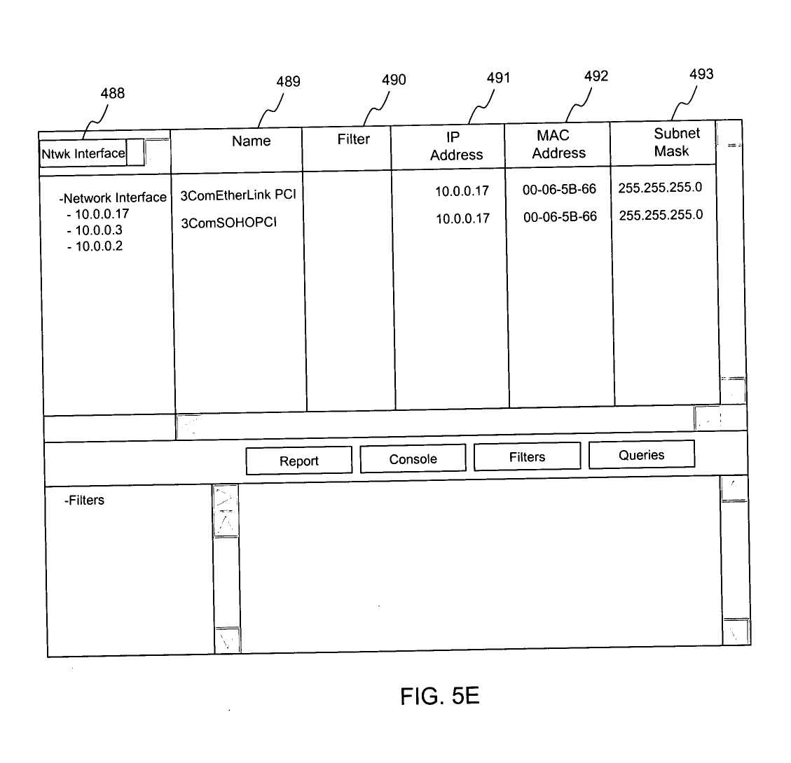

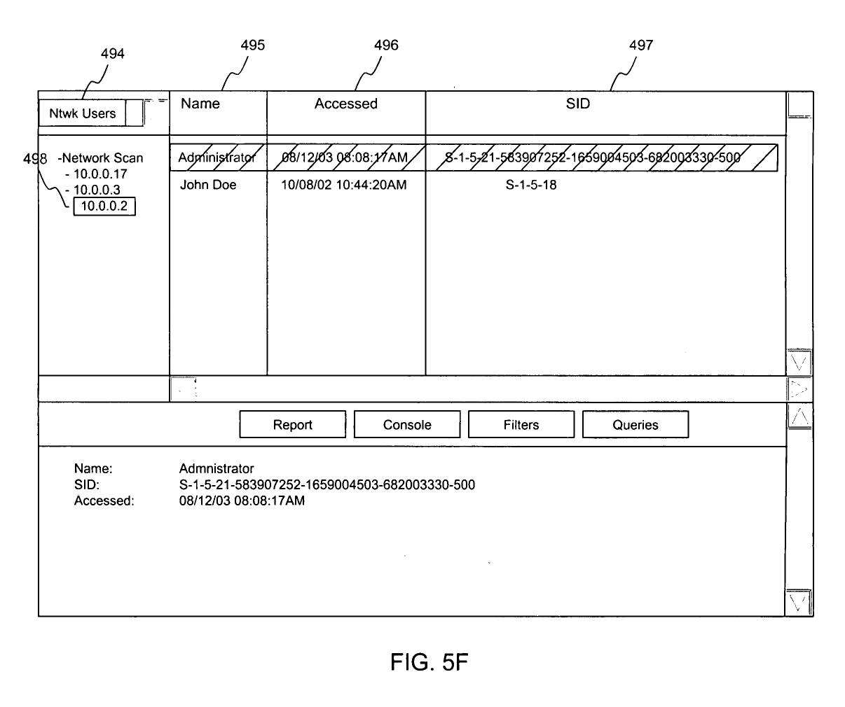

FIGS. 5A-5F are exemplary screen shots of a graphical user interface (GUI) 400 provided by the client software 116 for viewing and manipulating snapshot information returned by the target machines according to one embodiment of the invention. In response to a user actuation of a snapshot option 414, the GUI 400 displays in a snapshot window 410 the snapshot data returned by one or more target machines that have been selected by the examiner. The machines are identified according to their names, machine names, and IP addresses in respectively a name, machine name, and IP address columns 402, 403, 404. According to one embodiment of the invention, for each identified target machine, a number of open ports, active processes, and open files returned for that target machine are listed in respectively an open ports, processes, and open files columns 405, 406, 407. The machine profiles and associated comments corresponding to the identified target machines are displayed in respectively in a machine profile and comments columns 408, 409.

Additional information on a surveyed target machine may be provided in response to a highlighting of the machine from the snapshot window using a mouse or another user selection device, and a selecting of a particular column for which additional information desired. In the illustrated embodiment, the processes column 406 is selected for the first target machine displayed on the snapshot window 410, causing additional information about the processes active on the machine to be displayed. For example, a process name may be displayed in a process name field 416, a hash value may be displayed in a hash value field 418, a process ID may be displayed in an ID field 420, and a data and time in which the process started may be displayed in a start field 422.

According to one embodiment of the invention, the GUI 400 provides an open ports button 424 (FIG. 5B) which allows the display of information on the ports that were open on a selected target machine 452 at the time of the survey. FIG. 5B illustrates an open ports window 448 displaying information on the open ports on target machine “192.168.2.3” at the time of the survey.

For each open port, a name of the port is displayed in a name column 426, a protocol utilized on the port is displayed in a protocol column 428, a local port number is displayed in a local port column 430, a state of the port is displayed in a state column 432, and a process identifier associated with the port is displayed in a process ID column 440.

The names of the processes 444 running on the particular target machine for which port information is desired are also displayed in a separate window 456. According to one embodiment of the invention, the examiner may select from the open ports window 448, an entry 454 for a particular port to cause the highlighting of a particular process name 444a that is associated with the port in window 456. In the same manner, selection of the particular process name 444a in window 456 causes the highlighting of the entry 454 of the particular port to which the process is associated. In this manner, information on open ports may be correlated to information on processes that are tied to the ports. In the illustrated example, a suspicious process with a name “..” is listening on port 31337. The process is suspicious because the file name “..” indicates that the file is a hidden file.

According to one embodiment of the invention, the GUI provides a set of pre-coded filters 446 that may be selected to filter the results displayed on the open ports window 448. If a filter has been enabled, the name of the filter is displayed on a filter column 442. In the illustrated embodiment, a listening ports filter 446a is invoked to cause the open ports window 448 to only display information on ports that are deemed to be in a listening state. The computer program code for the selected filter is further displayed in a code window 450. This allows each filter to be programmed by the examiner directly from the code window 450.

According to one embodiment of the invention, the GUI further provides a processes button 460 (FIG. 5C) which causes the display of active processes that were running in one or more selected target machines at the time of the survey. FIG. 5C illustrates a process window 470 displaying information on the processes running on target machine “192.168.2.3” at the time of the survey.

For each process active on the selected target machine, the process window 470 displays a process name in a name column 462, an application descriptor in an application descriptor column 464, an application comment in an application comments column 466, and a corresponding hash value in a hash values column 468. The process name is displayed from the data captured from the target machine 117. The application descriptor and application comments are retrieved from a corresponding application descriptor record maintained in the application descriptor database for the process.

In the illustrated embodiment, the application descriptor and comment columns 464, 466 indicate that the highlighted process 472 with the name “..” is an unauthorized application known as “netcat.” A status column 469 further indicates the status of the application is “not approved.” As described above, this determination is made upon examination of the machine profile applicable to the target machine running the process, and identification from the machine profile of the processes that have been authorized for the machine's profile. Detailed information about the process may also be displayed in a report format in a separate reports window 474.

The GUI further provides an open files button 480 (FIG. 5D) which causes a display of the files that are used by one or more processes active in a target machine at the time of the survey. FIG. 5D illustrates an open files window 486 displaying information on the files that were in use by a particular process 487 running on target machine “192.168.2.3” at the time of the survey.

For each open file, the files window 486 displays a file name in a name column 481, a filter that has been applied to the results displayed in the open files window 486 in a filter column 482, a process ID in a process ID column 483, a file ID in a file ID column 484, and a file path in a file path column 485. The correlation of open file information to their corresponding processes allows an examiner to gain a better understanding of the information that a particular suspicious process, such as, in the current example, a process named “..” is trying to access from the machine. The examiner may further examine static data on the target machine's hard drive including file systems, memory dumps, system logs, network data, operating system artifacts, and the like, as is described in further detail in U.S. application Ser. No. 10/176,349.

Other data available via the GUI includes information on the network interface cards used in a target machine and the users logged onto the machine. FIG. 5E illustrates a network interface button 488 which allows the display of information on the manufacturer 489 of a network interface card, a filter 490 for filtering the displayed information, an IP address 491 assigned to the card, a MAC address 492, and a subnet mask 493.

FIG. 5F illustrates a network users button 494 which may be selected to display information on the users who have logged-on to a machine connected to the network at a particular network address 498. Such information may include the user's name 495, the date and time of the access 496, and the user's security ID 497. This information may also be displayed in a report format on a reports window 499. A timeline of the login activity of the users may also be displayed on a timeline window (not shown).

FIG. 6 is a flow diagram of a process for establishing a secure communication between the client software 116 resident in the examining machine 115 and a secure server 111 according to one embodiment of the invention. In general terms, the client software, in step 600, generates an examiner's random number “Erand” and includes it into a packet along with the examiner's user name. In step 602, the client software signs the packet with a user authentication private key as is understood by those of skill in the art. In step 604, the client software encrypts the signed packet with the secure server's public key according to conventional mechanisms, and transmits the encrypted, signed packet to the secure server 111 in step 606.

In step 608, the secure server 111 receives the packet and invokes its computer investigation software 109 to decrypt the packet using the server's private key. In step 610 the software 109 retrieves the examiner's user name from the packet and searches the server's database for a match. The matched name in the server's database includes a public user authentication key which is used in step 612 to verify the user's signature on the packet according to conventional mechanisms. If the signature is not verified, as determined in step 614, the client software cannot be authenticated and a connection between the client software and the secure server is denied in step 616.

If, however, the signature is verified, the client software may be authenticated, and the computer investigation software 109 stores the examiner's random number in step 618.

In step 620, the processor generates its own server random number “Srand” and a server-to-examiner session encryption key “SEkey” to be used to encrypt future communications between the server and the examiner. These values, as well as the original examiner's random number are signed with the server's private key in step 622, encrypted with the user's public key in step 624, and transmitted to the client software in step 626.

In step 628, the client software 116 receives the packet from the secure server and decrypts it using the user's private key. In step 630, the client software verifies the server's signature with the server's public key according to conventional mechanisms. In step 632, a determination is made as to whether the signature may be verified. If the answer is YES, the server is authenticated, and the client software verifies the examiner's random number that is transmitted by the server to confirm that it is, in fact, the same number that was sent to the server. If the number may be confirmed, as is determined in step 634, the examiner creates another packet to send back to the server 111. This packet includes the server random number which is encrypted, in step 636, with the server-to-examiner session key. The encrypted packet is then transmitted to the server.

In step 638, the server's computer investigation software 109 decrypts the packet containing the server random number with the server-to-examiner session key. If the received server random number is the same number originally generated and sent to the client software as is determined in step 640, the number is confirmed, and a secure connection is established in step 642. The process for establishing a secure connection between the client software and the secure server 111 is described in more detail in U.S. application Ser. No. 10/176,349.

Once a secure connection is established, an examiner may use its client software 116 to request investigation of the target machines across the network in support of incident response, information auditing, and forensic discovery. The secure server 111 authorizes and securely brokers requests and communications from the client software to the target machines. The communication between the server and the client software is encrypted using the server-to-examiner session encryption key.

FIG. 7 is a flow diagram of a process for establishing a secure communication between the secure server 111 and the servlet 118 according to one embodiment of the invention. A number of such secure communications may be established concurrently based on the number of processing threads 240 that have been spawned by the server.

In step 700, the server's computer investigation software 109 generates a second server random number “Srand2,” and signs the packet with the server's private key in step 702. In step 704, the software 109 transmits the signed packet to the servlet.

The servlet receives the packet signed with the second server random number, and in step 706, verifies the signature with the server's public key. If the signature cannot be verified, as is determined in step 708, a safe connection between the secure server 111 and the servlet 118 is denied in step 710.

If, however, the server's signature is verified, the servlet generates a servlet-to-server session encryption key in step 712 and inserts it into a packet in step 714 along with the second server random number. The servlet encrypts the packet in step 716 with the server's public key, and transmits the packet to the server 111.

In step 718, the server's computer investigation software 109 receives the encrypted packet and decrypts it with the server's private key. The processor further confirms in step 720, whether the second server random number is the same number that was originally sent to the servlet. If the answer is YES, the processor generates a server-to-servlet session encryption key in step 722, and encrypts the server-to-servlet session encryption key with the servlet-to-server session encryption key in step 724. In step 726, the encrypted packet is transmitted to the servlet.

In step 728, the servlet decrypts the packet with the servlet-to-server session key, and stores the server-to-servlet session key in step 730. In step 731, a secure connection is established, and all subsequent data exchanges between the server and the servlet are encrypted using the server-to-sevlet session key. The establishment of a secure connection between the secure server 111 and the servlet 118 is described in more detail in U.S. application Ser. No. 10/176,349.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the Applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for concurrently investigating a plurality of target devices in a data communications network, the method comprising:
receiving over a network connection a request transmitted by a remote device, wherein the request is associated with a range of network addresses in the data communications network;
concurrently surveying, in response to the request, at least a portion of the network addresses for a responding target device connected to the network via a surveyed network address;
establishing concurrent connections with a plurality of responding target devices;
invoking a plurality of investigative processes, the processes being concurrently executed on the plurality of responding target devices;
transmitting to the remote device connection information associated with the plurality of responding target devices;
establishing concurrent connections between the remote device and the plurality of responding target devices based on the connection information;
concurrently receiving at the remote device data generated by the plurality of responding target devices in response to the investigative processes;
correlating the received data based on a correlating criteria; and
displaying the correlated data on a display coupled to the remote device.

2. The method of claim 1, wherein the investigative process retrieves volatile data from a local memory of a responding target device.

3. The method of claim 2, wherein the volatile data is data stored in a random access memory of the responding target device.

4. The method of claim 3, wherein the volatile data is information on an active process running on the responding target device.

5. The method of claim 3, wherein the volatile data is information on a communication port open on the responding target device.

6. The method of claim 3, wherein the volatile data is information on a file open on the responding target device.

7. The method of claim 1 further comprising manipulating the displayed data via a graphical user interface.

8. The method of claim 7, wherein the manipulating is filtering the displayed data based on a selected filter.

9. The method of claim 8, wherein the filter is programmable via the graphical user interface.

10. The method of claim 1, wherein the correlating includes correlating information on communication ports open on a responding target device with information on processes active on the device.

11. The method of claim 1, wherein the correlating includes correlating information on processes active on the responding target device with information on files open on the device.

12. The method of claim 1, wherein the correlating includes correlating information on processes active on the responding target device with information on processes authorized for the target device.

13. The method of claim 12 further comprising:
associating a machine profile to a first target device, the machine profile including information on one or more processes authorized for the machine profile;
receiving first volatile data transmitted by the first target device, the first volatile data including information on a process active on the first target device;
retrieving the target profile for the first target device;
determining based on the machine profile whether the active process is an authorized process; and
displaying authorization information based on the determination.

14. The method of claim 13 further comprising:
generating a description of a plurality of known processes;
storing the description in a data store;
searching the data store for the active process; and
displaying a description of the active process upon a match.

15. The method of claim 14 wherein searching the data store includes searching the data store for a hash value associated with the active process.

16. The method of claim 1 further comprising establishing a secure communication with the remote device including:
generating an encryption key;
transmitting the encryption key to the remote device;
receiving an authentication key from the remote device; and
authenticating the remote device based on the authentication key.

17. The method of claim 16 further comprising receiving from the remote device a data packet encrypted using the encryption key.

18. The method of claim 1 further comprising establishing a secure communication with a particular target device including:
receiving a first encryption key generated by the particular target device;
generating a second encryption key; and
transmitting the second encryption key to the particular target device, wherein the second encryption key is encrypted via the first encryption key.

19. The method of claim 18 further comprising receiving from the particular target device a data packet encrypted using the second encryption key.

20. In a data communications network including a remote device and a plurality of target devices, a concurrent investigation server comprising:
means for receiving a request transmitted by the remote device, wherein the request is associated with a range of network addresses in the data communications network;
means for concurrently surveying, in response to the request, at least a portion of the network addresses for a responding target device connected to the network via a surveyed network address;
means for establishing concurrent connections with a plurality of responding target devices;
means for invoking a plurality of investigative processes, the processes being concurrently executed on the plurality of responding target devices;
means for transmitting to the remote device connection information associated with the plurality of responding target devices, wherein:
concurrent connections are established between the remote device and the plurality of responding target devices;
the remote device concurrently receives data generated by the plurality of responding target devices in response to the investigative processes;
the received data is correlated based on a correlating criteria; and
the correlated data is displayed on a display coupled to the remote device.

21. The server of claim 20, wherein the investigative process retrieves volatile data from a local memory of a responding target device.

22. The server of claim 21, wherein the volatile data is data stored in a random access memory of the responding target device.

23. The server of claim 21, wherein the volatile data is information on an active process running on the responding target device.

24. The server of claim 21, wherein the volatile data is information on a communication port open on the responding target device.

25. The server of claim 21, wherein the volatile data is information on a file open on the responding target device.

26. The server of claim 20, wherein the remote device includes a graphical user interface for manipulating the displayed data.

27. The server of claim 26, wherein the manipulating is filtering the displayed data based on a selected filter.

28. The server of claim 27, wherein the filter is programmable via the graphical user interface.

29. The server of claim 20, wherein the means for correlating includes means for correlating information on communication ports open on a responding target device with information on processes active on the device.

30. The server of claim 20, wherein the means for correlating includes means for correlating information on processes active on the responding target device with information on files open on the device.

31. The server of claim 20, wherein the means for correlating includes means for correlating information on processes active on the responding target device with information on processes authorized for the target device.

32. The server of claim 31, wherein the remote device includes:
means for associating a machine profile to a first target device, the machine profile including information on one or more processes authorized for the machine profile;
means for receiving first volatile data transmitted by the first target device, the first volatile data including information on a process active on the first target device;
means for retrieving the target profile for the first target device;
means for determining based on the machine profile whether the active process is an authorized process; and
means for displaying authorization information based on the determination.

33. The server of claim 32, wherein the remote device further includes:
means for generating a description of a plurality of known processes;
means for storing the description in a data store;
means for searching the data store for the active process; and
means for displaying a description of the active process upon a match.

34. The server of claim 33, wherein the means for searching includes means for searching the data store for a hash value associated with the process.

35. The server of claim 20 further comprising means for establishing a secure communication with the remote device including:
means for generating an encryption key;
means for transmitting the encryption key to the remote device;
means for receiving an authentication key from the remote device; and
means for authenticating the remote device based on the authentication key.

36. The server of claim 35 further comprising means for receiving from the remote device a data packet encrypted using the encryption key.

37. The server of claim 20 further comprising means for establishing a secure communication with a particular target device including:
means for receiving a first encryption key generated by the particular target device;
means for generating a second encryption key; and
means for transmitting the second encryption key to the particular target device, wherein the second encryption key is encrypted via the first encryption key.

38. The server of claim 37 further comprising means for receiving from the particular target device a data packet encrypted using the second encryption key.

39. A concurrent investigation system of network devices in a data communications network, the system comprising:
a remote device transmitting a first request over a network connection, wherein the first request is associated with a range of network addresses in the data communications network; and
a server receiving the first request and invoking a plurality of processing threads in response, each processing thread being assigned a network address from the range of network addresses or names of machines, the processing threads concurrently attempting a connection with a plurality of network devices at the assigned network addresses, wherein in response to successful connections with a plurality of responding network devices, a plurality of investigative processes are concurrently invoked on the plurality of responding network devices, and connection information for the plurality of responding network devices is returned to the server, the server forwarding the connection information to the remote device in response to a second request, the remote device establishing concurrent connections with the plurality of responding network devices based on the connection information, wherein the remote device concurrently receives data generated by the plurality of responding network devices in response to the investigative processes, correlates the received data based on a correlating criteria, and displays the correlated data on a display.
